(19) United States
(12) Patent Application Publication
(10) Pub. No.: US 2011/0188436 A1
(43) Pub. Date: Aug. 4, 2011

(54) METHOD AND APPARATUS FOR SENDING SCHEDULING INFORMATION FOR BROADCAST/MULTICAST SERVICES

(75) Inventors: Jelena M. Damnjanovic, San Diego, CA (US); Nathan Edward Tenny, San Diego, CA (US)

(73) Assignee: QUALCOMM INCORPORATED, San Diego, CA (US)

(21) Appl. No.: 12/850,073

(22) Filed: Aug. 4, 2010

Related U.S. Application Data
(60) Provisional application No. 61/231,947, filed on Aug. 6, 2009.
(60) Provisional application No. 61/232,328, filed on Aug. 7, 2009.

(51) Int. Cl. H04W 4/06

(52) U.S. Cl. 370/312

(57) ABSTRACT

Techniques for supporting multimedia broadcast/multicast services (MBMS) are described. A group of base stations/cells may support a number of MBMS services and may transmit any set of MBMS services in a given scheduling period. In one design, a base station may determine scheduling information for a plurality of MBMS services, generate a bitmap based on the scheduling information, and send the bitmap to convey the scheduling information. The bitmap may include a bit for each MBMS service, and the bit may indicate whether or not that MBMS service is scheduled. In one design, the bitmap may cover all MBMS services supported by the base station. In another design, a plurality of groups of MBMS services may be formed for all supported MBMS services. A group of MBMS services may be selected from among the plurality of groups, and the bitmap may be for the MBMS services in the selected group.

The present application claims priority to provisional U.S. Application Ser. No. 61/231,947, filed Aug. 6, 2009, and provisional U.S. Application Ser. No. 61/232,328, filed Aug. 7, 2009, both entitled “Method and Apparatus for Dynamic Scheduling of Services for Evolved Multicast Broadcast Multimedia Service (eMBMS),” assigned to the assignee hereof, and incorporated herein by reference.

### BACKGROUND

I. Field

The present disclosure relates generally to communication, and more specifically to techniques for supporting broadcast/multicast services in a wireless communication network.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may support broadcast, multicast, and unicast services. A broadcast service is a service that may be received by all users, e.g., news broadcast. A multicast service is a service that may be received by a group of users, e.g., a subscription video service. A unicast service is a service intended for a specific user, e.g., voice call. It may be desirable to efficiently support broadcast/multicast services in the wireless network.

### SUMMARY

Techniques for supporting multimedia broadcast/multicast services (MBMS) in a wireless communication network are described herein. A group of base stations or cells may support a number of MBMS services and may transmit any set of MBMS services in a given scheduling period. In an aspect, scheduling information may be sent in at least one bitmap to convey which MBMS services are scheduled in the current scheduling period.

In one design, a base station for a cell may determine scheduling information for a plurality of MBMS services. The base station may generate a bitmap based on the scheduling information. The base station may send at least the bitmap to convey the scheduling information. In one design, the scheduling information may indicate whether each of the plurality of MBMS services is scheduled in the current scheduling period. In one design, the bitmap may comprise a bit for each of the plurality of MBMS services, and the bit for each MBMS service may indicate whether or not that MBMS service is scheduled. In one design, the plurality of MBMS services may include all MBMS services supported by the base station/cell, and the bitmap may be for all supported MBMS services. In another design, a plurality of groups of MBMS services may be formed for all supported MBMS services. The base station may select a group of MBMS services among the plurality of groups. The selected group may include the plurality of MBMS services, and the bitmap may be for the MBMS services in the selected group. In this design, the base station may also send information indicating the selected group. The base station may also send one or more additional bitmaps for one or more additional groups of MBMS services being scheduled.

In one design, a user equipment (UE) may receive the bitmap used to convey the scheduling information for the plurality of MBMS services. The UE may determine whether at least one MBMS service of interest to the UE is scheduled based on the bitmap. In one design, the UE may determine at least one bit of the bitmap to which the at least one MBMS service is mapped. The UE may determine whether each MBMS service is scheduled based on the value of the corresponding bit of the bitmap.

Various aspects and features of the disclosure are described in further detail below.

### BRIEF DESCRIPTION OF THE DRAWINGS

FIG. 1 shows a wireless communication network.

FIG. 2 shows an exemplary frame structure.

FIG. 3 shows subframes for MBMS services.

FIG. 4 shows exemplary transmissions of various channels for MBMS.

FIG. 5 shows a bitmap for all supported MBMS services.

FIG. 6 shows a bitmap for MBMS services in a selected group.

FIGS. 7 and 8 show a process and an apparatus, respectively, for sending scheduling information for MBMS services.

FIGS. 9 and 10 show a process and an apparatus, respectively, for receiving scheduling information for MBMS services.

FIG. 11 shows a block diagram of a base station and a UE.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

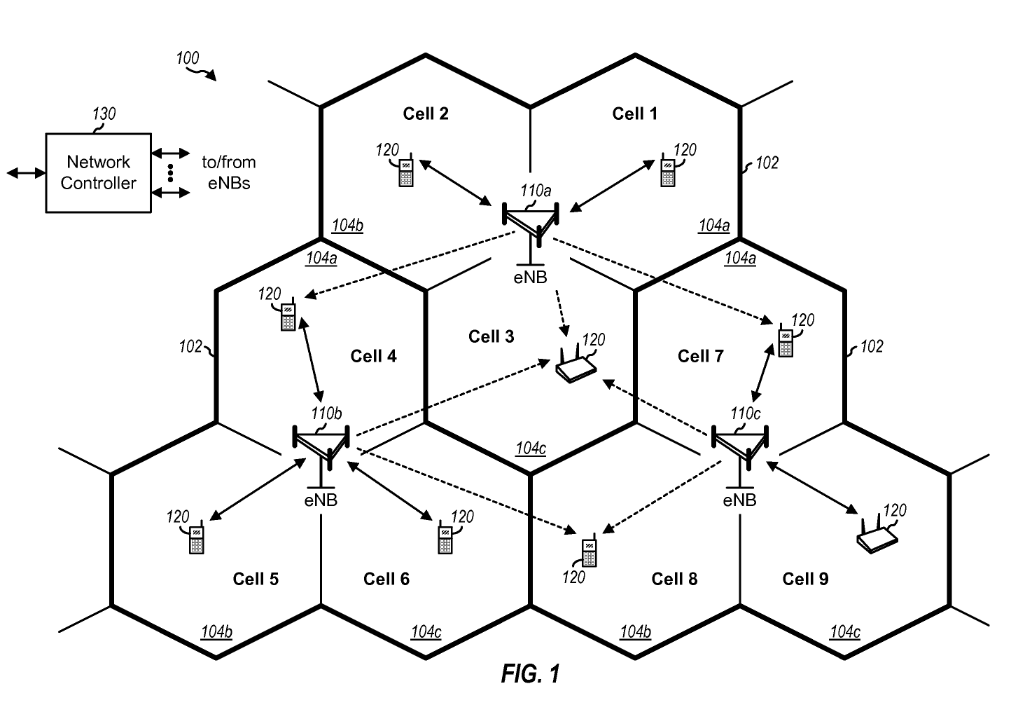

FIG. 1 shows a wireless communication network 100, which may be an LTE network or some other wireless network. Wireless network 100 may include a number of evolved Node Bs (eNBs) and other network entities. For simplicity, only three eNBs 110a, 110b and 110c and one network controller 130 are shown in FIG. 1. An eNB may be an entity that communicates with the UEs and may also be referred to as a base station, a Node B, an access point, etc. Each eNB 110 may provide communication coverage for a particular geographic area and may support communication for the UEs located within the coverage area. To improve network capacity, the overall coverage area 102 of an eNB may be partitioned into multiple (e.g., three) smaller areas 104a, 104b and 104c. Each smaller area may be served by a respective eNB subsystem. In 3GPP, the term “cell” can refer to the smallest coverage area of an eNB and/or an eNB subsystem serving this coverage area. In 3GPP2, the term “sector” or “cell-sector” can refer to the smallest coverage area of a base station and/or a base station subsystem serving this coverage area. For clarity, 3GPP concept of cell is used in the description below.

UEs 120 may be dispersed throughout the wireless network, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may communicate with an eNB via the downlink and uplink. The downlink (or forward link) refers to the communication link from the eNB to the UE, and the uplink (or reverse link) refers to the communication link from the UE to the eNB. In FIG. 1, a solid line with double arrows indicates bi-directional communication between an eNB and a UE. A dashed line with a single arrow indicates a UE receiving a downlink signal from an eNB, e.g., for broadcast and/or multicast services.

Wireless network 100 may support MBMS services for multiple UEs as well as unicast services for individual UEs. A MBMS service may be a broadcast service or a multicast service. The MBMS services may be supported with a multi-cell mode, a single-cell mode, and/or other modes. In the multi-cell mode, multiple cells may simultaneously send a MBMS transmission using multimedia broadcast single frequency network (MBSFN), which may allow a UE to combine the signals received from the multiple cells in order to improve reception performance. In the single-cell mode, a cell may send a MBMS transmission by itself.

In LTE, data and overhead information are processed as logical channels at a Radio Link Control (RLC) layer. The logical channels are mapped to transport channels at a Medium Access Control (MAC) layer. The transport channels are mapped to physical channels at a physical layer (PHY). Table 1 lists some logical channels (denoted as “L”), transport channels (denoted as “T”), and physical channels (denoted as “P”) used in LTE to support MBMS and provides a short description of each channel.

TABLE 1

| Channel | Name | Type | Description |
|---|---|---|---|
| Broadcast Control Channel | BCCH | L | Carry system information. |
| Multicast Control Channel | MCCH | L | Carry MBMS control |
| | | | information. |
| Multicast Traffic Channel | MTCH | L | Carry data for MBMS |
| | | | services. |
| Broadcast Channel | BCH | T | Carry the BCCH |
| Multicast Channel | MCH | T | Carry the MTCH and |
| | | | MCCH. |
| Physical Broadcast Channel | PBCH | P | Carry the BCH. |
| Physical Multicast Channel | PMCH | P | Carry the MCH. |

The BCCH may carry system information blocks (SIBs), with each SIB including certain system information pertinent for communicating with and/or receiving data from a cell. The MCCH may carry control information used to receive MBMS services, e.g., a list of MBMS services with ongoing sessions, information used to receive the MTCH, etc. The MTCH may carry data for the MBMS services.

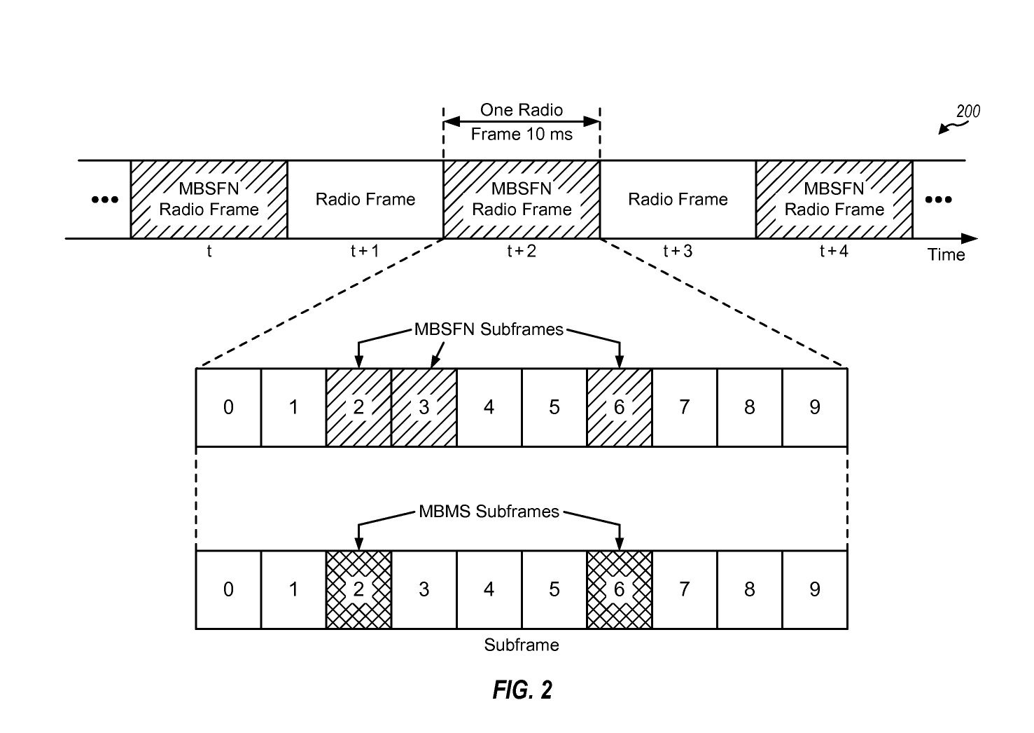

FIG. 2 shows an exemplary frame structure 200 for the downlink in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include L symbol periods, e.g., 14 symbol periods for a normal cyclic prefix or 12 symbol periods for an extended cyclic prefix (not shown in FIG. 2).

Some or all of the available radio frames for a cell may be designated as MBSFN radio frames. A MBSFN radio frame is a radio frame in which MBMS services and other designated services can be sent. In the example shown in FIG. 2, every other radio frame is designated as a MBSFN radio frame. Within each MBSFN radio frame, one or more subframes may be designated as MBSFN subframes. A MBSFN subframe is a subframe in which MBMS services and other designated services can be sent. A MBSFN subframe may have a format that is different from a regular subframe used to send unicast data to specific UEs. In the example shown in FIG. 2, subframes 2, 3 and 6 of each MBSFN radio frame are designated as MBSFN subframes. One or more MBSFN subframes in each MBSFN radio frame may be designated as MBMS subframes. A MBMS subframe is a subframe in which a MBMS transmission for MBMS services can be sent. In the example shown in FIG. 2, subframes 2 and 6 of each MBSFN radio frame are designated as MBMS subframes.

A group of cells in a MBSFN area may collectively send a MBMS transmission for a number of MBMS services, with each cell sending the same MBMS transmission. A UE may receive the MBMS transmission from the group of cells, which may appear as a single transmission to the UE. The group of cells may transmit one MCCH and one or more MTCHs for the MBMS transmission. The MCCH may carry control information for all MTCHs. Each MTCH may carry data for one or more MBMS services. The group of cells may transmit one or more MCHs. The MCCH may be sent in one MCH, and one or more MTCHs may be sent in each MCH. Multiple MCHs may be used to support (i) different groups of MBMS services with different quality-of-service (QoS) requirements and/or (ii) more MBMS services.

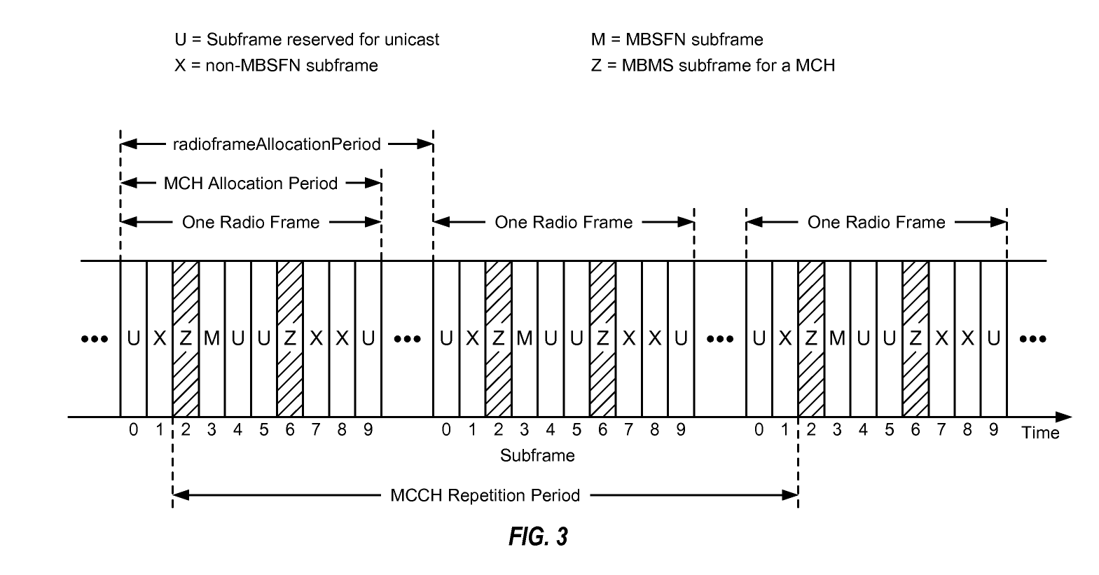

FIG. 3 shows an exemplary sequence of MBMS subframes for a MCH. The MCH may be sent in the sequence of MBMS subframes, which may be defined by a MCH subframe allocation pattern (MSAP). The MSAP indicates which ones of the MBSFN subframes are used for the MCH. In general, a MSAP for a MCH may include all or a subset of the available MBMS subframes. The MBMS subframes used for the MCH are referred to as MCH subframes and are denoted as “Z” in FIG. 3. The exemplary sequence of MBMS subframes in FIG. 3 corresponds to the exemplary MBMS configuration shown in FIG. 2 in which subframes 2, 3 and 6 in certain radio frames are MBSFN subframes. The sequence of MBMS subframes spans a particular time period, which may be referred to as a MCH allocation period, a MSAP period, a MSAP occasion, etc. The sequence of MBMS subframes would repeat in each MCH allocation period.

In the example shown in FIG. 3, the sequence of MBMS subframes spans a MCH allocation period of one MBSFN radio frame. The MBSFN radio frame includes three MBSFN subframes 2, 3, and 6, and the sequence of MBMS subframes includes MBMS subframes 2 and 6 in the MBSFN radio frame. In general, each MCH may be associated with a specific sequence of MBMS subframes defined by the MSAP for that MCH. The MSAPs for all MCHs may be conveyed by the MCCH, or in a SIB sent in the BCCH, or via some other mechanism.

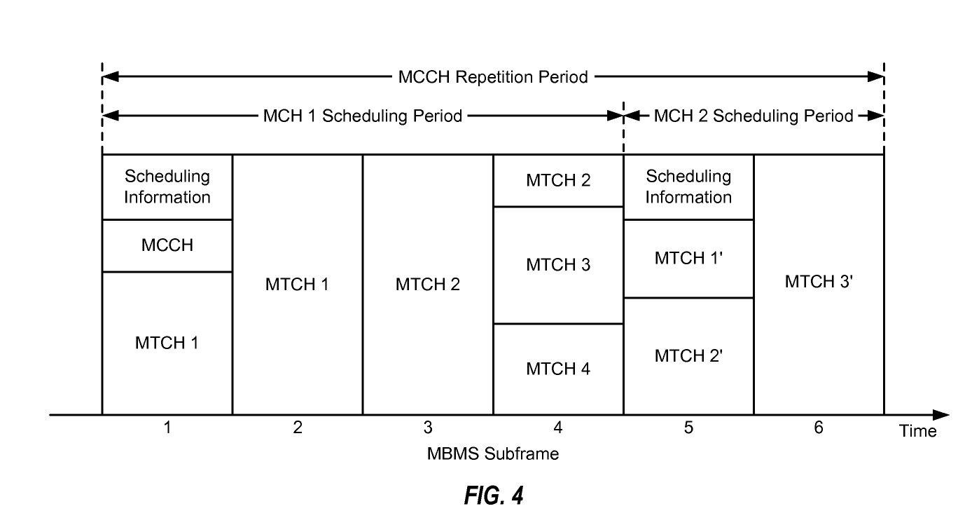

FIG. 4 shows exemplary transmissions of the MCCH and MTCHs. In the example shown in FIG. 4, a group of cells transmits two MCHs referred to as MCH 1 and MCH 2. The group of cells transmits the MCCH and MTCHs 1, 2, 3 and 4 in MCH 1 and transmits MTCHs 1′, 2′ and 3′ in MCH 2. For clarity, FIG. 4 shows only MBMS subframes and omits all other subframes.

The group of cells may transmit scheduling information for each MCH in each MCH scheduling period. The scheduling information may also be referred to as MCH scheduling information (MSI), dynamic scheduling information (DSI), etc. In one design, the scheduling information for each MCH may convey which MBMS subframes in the current MCH scheduling period are used for the MTCHs sent in that MCH. The scheduling information may also convey other information used by the UEs to receive MBMS services of interest. The scheduling information may be sent in a Medium Access Control (MAC) control element, or in the MCCH, or via some other channel or mechanism.

The group of cells may transmit the MCCH at the start of each MCCH repetition period, prior to any MTCH. The group of cells may also transmit the MTCH(s) for each MCH as indicated by the scheduling information for that MCH.

In an aspect, the scheduling information for each MCH may convey which MBMS services are scheduled in the current MCH scheduling period for that MCH. A group of cells may support a number of MBMS services. However, not all MBMS services may be transmitted in each MCH scheduling period. The scheduling information may inform the UEs of which MBMS services are scheduled in the current MCH scheduling period, so that the UEs can know whether they can expect MBMS services of interest. The information regarding the scheduled MBMS services may be provided in various manners.

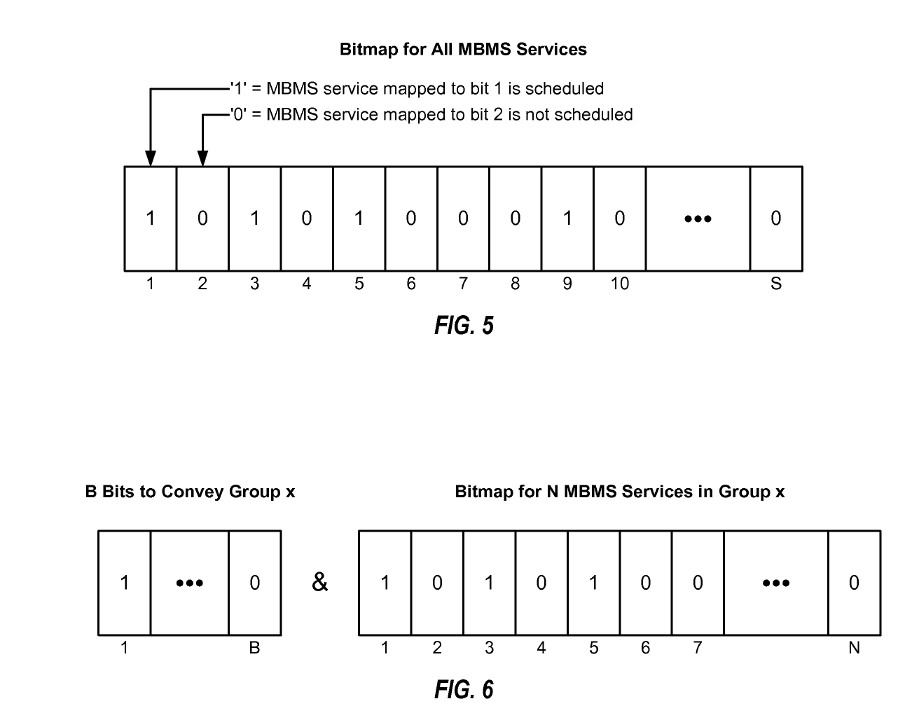

FIG. 5 shows a first design in which information regarding which MBMS services are scheduled is provided by a bitmap. S MBMS services may be supported by a group of cells, where S may be any value. The bitmap may include S bits, one bit for each MBMS service. The bit for each MBMS service may be set to (i) a first value (e.g., ‘1’) to indicate that the MBMS service is scheduled in the current MCH scheduling period or (ii) a second value (e.g., ‘0’) to indicate that the MBMS service is not scheduled.

FIG. 6 shows a second design in which information regarding which MBMS services are scheduled is provided by a group indication and a bitmap. S MBMS services may be supported by a group of cells and may be divided into multiple (G) groups, where G may be any value. In general, any number of groups may be formed, each group may include any number of MBMS services, and the groups may include the same or different numbers of MBMS services. Information regarding which MBMS services are scheduled may be provided by (i) information indicating one or more groups of MBMS services selected for scheduling and (ii) a bitmap for each selected group to indicate which MBMS services in that selected group are scheduled. The bitmap for each selected group may include one bit for each MBMS service in that group. The bit for each MBMS service may indicate whether or not that MBMS service is scheduled in the current MCH scheduling period.

In general, G groups may be formed, and each group may include N or fewer MBMS services, where G>1 and N>1. In one design, a group selected for scheduling may be conveyed with B=┌log₂(G)┐ bits, where “┌ ┐” denotes a ceiling operator. A bitmap for the selected group may include N bits for up to N MBMS services in the selected group. If one group is selected, as show in FIG. 6, then the information regarding which MBMS services are scheduled may include T=B+N bits, with B bits being used to specify the selected group and N bits being used to specify the scheduled MBMS services in the selected group. If multiple groups are selected, then the scheduling information may include T bits for each scheduled group.

In another design, a bitmap with G bits may be defined for the G groups of MBMS services. The bit for each group may be set to a first value (e.g., ‘1’) to indicate that the group is selected or to a second value (e.g., ‘0’) to indicate that the group is not selected. The information regarding which MBMS services are scheduled may be provided by (i) the bitmap for the G groups and (ii) one bitmap for each selected group.

The second design may have less overhead than the first design, especially when there is a large number of MBMS services, e.g., hundreds of MBMS services. In this case, a large number of bits may be needed for the bitmap for all MBMS services used in the first design, and overhead for this bitmap may be high. However, not all MBMS services may be scheduled in a given MCH scheduling period. In this case, dividing the MBMS services into groups and scheduling one or more MBMS services in one or more groups in each MCH scheduling period may reduce overhead. For example, 100 MBMS services may be supported and may be divided into 10 groups, with each group including 10 MBMS services. The scheduled MBMS services in one group may be conveyed with (i) 100 bits for a bitmap for all 100 MBMS services for the first design in FIG. 5 or (ii) 14 bits for the second design in FIG. 6, with 4 bits being used to indicate the selected group and 10 bits being used for a bitmap for the 10 MBMS services in the selected group. The design in FIG. 6 may thus substantially reduce overhead since the T bits need for the second design may be much fewer than the S bits needed for the first design.

The G groups of MBMS services may be formed in various manners. In one design, the G groups may be used to differentiate MBMS services offered in different MBSFN areas. For example, MBSFN area 1 may include certain groups of MBMS services (e.g., groups a and b) while MBSFN area 2 may include other groups of MBMS services (e.g., groups c and d). UEs capable of receiving one MBSFN area may be able to recognize only groups of MBMS services in that MBSFN area (e.g., only groups a and b if the UEs are capable of receiving MBSFN area 1 in the example above). UEs capable of receiving multiple MBSFN areas may be aware of all groups of MBMS services in all MBSFN areas that these UEs can receive. In another design, the G groups may be used to differentiate MBMS services based on other criteria.

In one design, MBMS services within each group may be assigned unique service identities (IDs). Each MBMS service may be specifically addressed based on its service ID. In one design, MBMS services in different groups may reuse service IDs, which may reduce the number of bits needed for each service ID. Each MBMS service may be specifically addressed based on its service ID and the group in which the MBMS service belongs, if necessary to avoid ambiguity between different MBMS services in different groups.

The MBMS services may be mapped to groups in various manners. In one design, each MBMS service may be mapped to only one group and may be scheduled when that group is selected. This design may result in the fewest number of groups and/or the fewest number of MBMS services in each group, which may reduce overhead. In another design, each MBMS service may be mapped to one or more groups and may be scheduled when any group in which the MBMS service belongs is selected. For example, a more popular MBMS service may be included in more groups whereas a less popular MBMS service may be included in only one group. This design may provide more flexibility in scheduling MBMS services.

Scheduling may be performed in various manners. In one design, a single group may be selected in each MCH scheduling period, and one or more MBMS services in the selected group may be scheduled. In another design, one or more groups may be selected in each MCH scheduling period, and one or more MBMS services in each selected group may be scheduled.

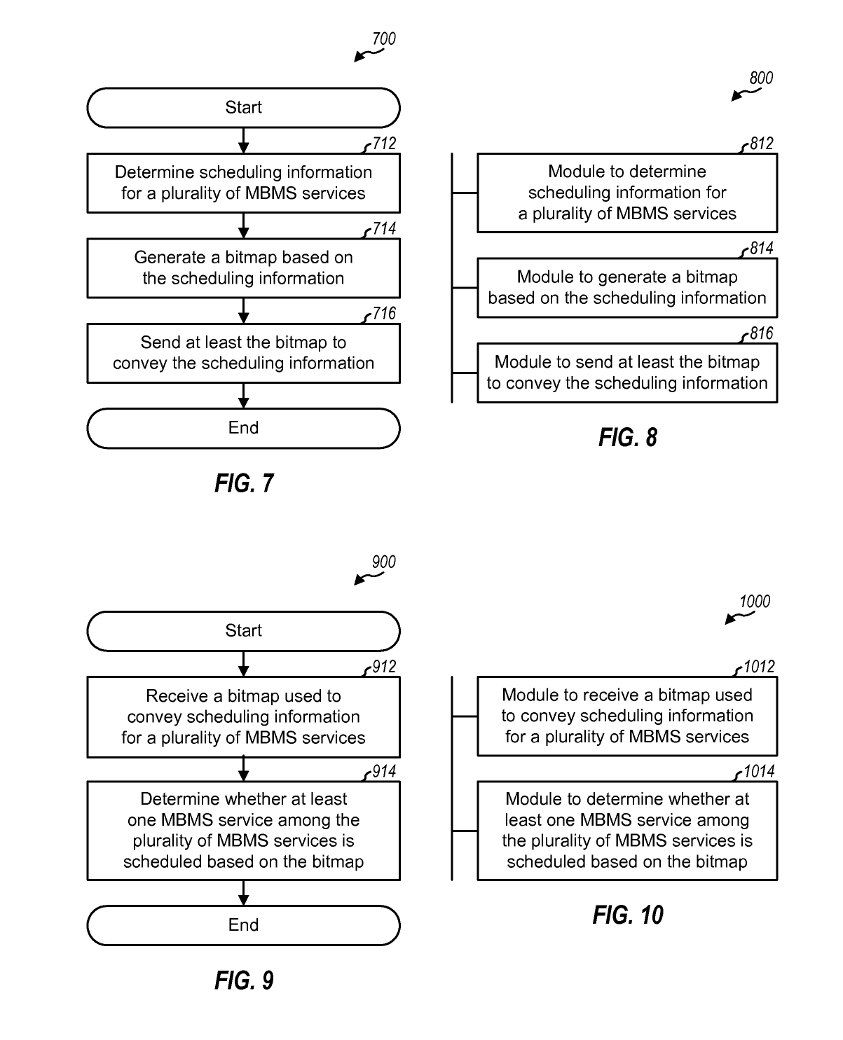

FIG. 7 shows a design of a process 700 for sending scheduling information for MBMS services. Process 700 may be performed by a base station for a cell (as described below) or by some other entity. The base station may determine scheduling information for a plurality of MBMS services (block 712). The base station may generate a bitmap based on the scheduling information (block 714). The base station may send at least the bitmap to convey the scheduling information (block 716).

In one design, the scheduling information may indicate whether each of the plurality of MBMS services is scheduled in the current scheduling period. In one design, the bitmap may comprise a bit for each of the plurality of MBMS services. The bit for each MBMS service may be set to (i) a first value to indicate the MBMS service being scheduled or (ii) a second value to indicate the MBMS service not being scheduled.

In one design, the plurality of MBMS services may include all MBMS services supported by the base station/cell. The bitmap may be for all supported MBMS services, e.g., as shown in FIG. 5.

In another design, a plurality of groups of MBMS services may be formed for all supported MBMS services. The base station may select a group of MBMS services among the plurality of groups of MBMS services. The selected group may include the plurality of MBMS services, and the bitmap may be for the MBMS services in the selected group. The base station may send information indicating the selected group. This information may be provided by a B-bit index of the selected group or a G-bit bitmap for all groups.

In one design, only one group of MBMS services may be selected in each scheduling period, and only the MBMS services in the selected group may be scheduled. In another design, more than one group of MBMS services may be selected. In this design, the base station may select at least one additional group among the plurality of groups. The base station may generate at least one additional bitmap based on the scheduling information for the at least one additional group. The base station may send information indicating the at least one additional group and the at least one additional bitmap to convey the scheduling information for the at least one additional group of MBMS services.

In one design, the plurality of groups of MBMS services may be formed for a plurality of MBSFN areas. Each group may include MBMS services for one MBSFN area. In another design, the plurality of groups of MBMS services may be formed based on other criteria. In one design, each supported MBMS service may be placed in only one group. In another design, each supported MBMS service may be placed in one or more groups.

FIG. 8 shows a design of an apparatus 800 for sending scheduling information for MBMS services. Apparatus 800 includes a module 812 to determine scheduling information for a plurality of MBMS services, a module 814 to generate a bitmap based on the scheduling information, and a module 816 to send at least the bitmap to convey the scheduling information.

FIG. 9 shows a design of a process 900 for receiving scheduling information for MBMS services. Process 900 may be performed by a UE (as described below) or by some other entity. The UE may receive a bitmap used to convey scheduling information for a plurality of MBMS services (block 912). The UE may determine whether at least one MBMS service among the plurality of MBMS services is scheduled based on the bitmap (block 914).

In one design, the scheduling information may indicate whether each of the plurality of MBMS services is scheduled in the current scheduling period. The bitmap may include a bit for each of the plurality of MBMS services, and the bit for each MBMS service may indicate whether or not that MBMS service is scheduled. In one design of block 914, the UE may determine at least one bit of the bitmap to which the at least one MBMS service is mapped. The UE may determine whether each of the at least one MBMS service is scheduled based on a value of a corresponding bit of the bitmap. In one design, the bitmap may be for all MBMS services supported by a cell. The plurality of MBMS services may include all supported MBMS services. In another design, a plurality of groups of MBMS services may be formed for all supported MBMS services. In this design, the UE may receive information indicating a selected group of MBMS services among the plurality of groups of MBMS services. The selected group may include the plurality of MBMS services, and the bitmap may be for the MBMS services in the selected group.

In one design, only one group of MBMS services may be selected in each scheduling period, and only the MBMS services in the selected group may be scheduled. In another design, more than one group of MBMS services may be selected. In this design, the UE may receive information indicating at least one additional group of MBMS services being selected. The UE may also receive at least one additional bitmap for the at least one additional group. The UE may determine whether at least one additional MBMS service in the at least one additional group is scheduled based on the at least one additional bitmap.

FIG. 10 shows a design of an apparatus 1000 for receiving scheduling information for MBMS services. Apparatus 1000 includes a module 1012 to receive a bitmap used to convey scheduling information for a plurality of MBMS services, and a module 1014 to determine whether at least one MBMS service among the plurality of MBMS services is scheduled based on the bitmap.

The modules in FIGS. 8 and 10 may comprise processors, electronic devices, hardware devices, electronic components, logical circuits, memories, software codes, firmware codes, etc., or any combination thereof.

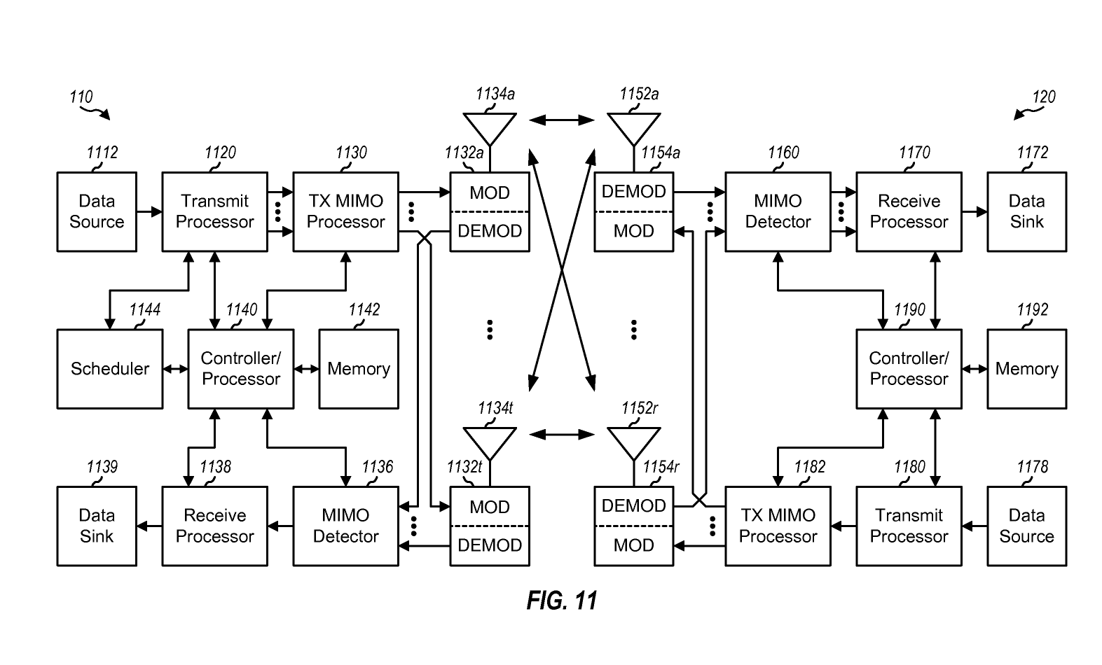

FIG. 11 shows a block diagram of a design of a base station/eNB 110 and a UE 120, which may be one of the base stations/eNBs and one of the UEs in FIG. 1. In this design, base station 110 may be equipped with T antennas 1134a through 1134t, and UE 120 may be equipped with R antennas 1152a through 1152r, where in general T≧1 and R≧1.

At base station 110, a transmit processor 1120 may receive data for unicast services and data for MBMS services from a data source 1112. Transmit processor 1120 may process the data for each service to obtain data symbols. Transmit processor 1120 may also receive overhead information from a controller/processor 1140 and/or a scheduler 1144 and may process the overhead information to obtain overhead symbols. The overhead information may comprise system information, control information, scheduling information, etc. A transmit (TX) multiple-input multiple-output (MIMO) processor 1130 may multiplex the data symbols, the overhead symbols, and reference symbols. Processor 1130 may further process (e.g., precode) the multiplexed symbols (if applicable) and may provide T output symbol streams to T modulators (MOD) 1132a through 1132t. Each modulator 1132 may process a respective output symbol stream (e.g., for OFDM, etc.) to obtain an output sample stream. Each modulator 1132 may further process (e.g., convert to analog, amplify, filter, and upconvert) the output sample stream to obtain a downlink signal. T downlink signals from modulators 1132a through 1132t may be transmitted via T antennas 1134a through 1134t, respectively.

At UE 120, antennas 1152a through 1152r may receive the downlink signals from base station 110 and other base stations and may provide received signals to demodulators (DEMOD) 1154a through 1154r, respectively. Each demodulator 1154 may condition (e.g., filter, amplify, downconvert, and digitize) a respective received signal to obtain received samples and may further process the received samples (e.g., for OFDM, etc.) to obtain received symbols. A MIMO detector 1160 may obtain the received symbols from all R demodulators 1154a through 1154r, perform MIMO detection on the received symbols (if applicable), and provide detected symbols. A receive processor 1170 may process the detected symbols, provide decoded data for UE 120 and/or the desired MBMS services to a data sink 1172, and provide decoded overhead information to a controller/processor 1190.

On the uplink, at UE 120, data from a data source 1178 and control information from controller/processor 1190 may be processed by a transmit processor 1180, further processed by a TX MIMO processor 1182 (if applicable), conditioned by modulators 1154a through 1154r, and transmitted via antennas 1152a through 1152r. At base station 110, the uplink signals from UE 120 may be received by antennas 1134, conditioned by demodulators 1132, detected by a MIMO detector 1136, and processed by a receive processor 1138 to obtain the data and control information transmitted by UE 120. Processor 1138 may provide decoded data to a data sink 1139 and decoded control information to controller/processor 1140.

Controllers/processors 1140 and 1190 may direct the operation at base station 110 and UE 120, respectively. Processor 1140 and/or other processors and modules at base station 110 may implement or direct process 700 in FIG. 7 and/or other processes for the techniques described herein. Processor 1190 and/or other processors and modules at UE 120 may implement or direct process 900 in FIG. 9 and/or other processes for the techniques described herein. Memories 1142 and 1192 may store data and program codes for base station 110 and UE 120, respectively. Scheduler 1144 may schedule UEs for data transmission, schedule MBMS services, and assign resources to the scheduled UEs and MBMS services. Controller/processor 1140 and/or scheduler 1144 may provide scheduling information for the MBMS services.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of supporting multimedia broadcast/multicast services (MBMS), comprising:
determining scheduling information for a plurality of MBMS services;
generating a bitmap based on the scheduling information; and
sending at least the bitmap to convey the scheduling information.

2. The method of claim 1, wherein the scheduling information indicates whether each of the plurality of MBMS services is scheduled in a current scheduling period.

3. The method of claim 1, wherein the bitmap comprises a bit for each of the plurality of MBMS services, and wherein the bit for each MBMS service is set to a first value to indicate the MBMS service being scheduled or to a second value to indicate the MBMS service not being scheduled.

4. The method of claim 1, wherein the plurality of MBMS services include all MBMS services supported by a cell.

5. The method of claim 1, further comprising:
selecting a group of MBMS services among a plurality of groups of MBMS services formed for all MBMS services supported by a cell, wherein the selected group includes the plurality of MBMS services; and
sending information indicating the selected group.

6. The method of claim 5, wherein only one of the plurality of groups of MBMS services is selected in each scheduling period, and wherein only MBMS services in the selected group are scheduled.

7. The method of claim 5, further comprising:
selecting at least one additional group of MBMS services among the plurality of groups of MBMS services;
generating at least one additional bitmap based on scheduling information for the at least one additional group of MBMS services; and
sending information indicating the at least one additional group and the at least one additional bitmap to convey the scheduling information for the at least one additional group of MBMS services.

8. The method of claim 5, wherein the plurality of groups of MBMS services are formed for a plurality of multimedia broadcast single frequency network (MBSFN) areas, with each group including MBMS services for one MBSFN area.

9. The method of claim 5, wherein each supported MBMS service is placed in only one of the plurality of groups.

10. The method of claim 5, wherein each supported MBMS service is placed in one or more of the plurality of groups.

11. An apparatus for supporting multimedia broadcast/multicast services (MBMS), comprising:
means for determining scheduling information for a plurality of MBMS services;
means for generating a bitmap based on the scheduling information; and
means for sending at least the bitmap to convey the scheduling information.

12. The apparatus of claim 11, wherein the bitmap comprises a bit for each of the plurality of MBMS services, and wherein the bit for each MBMS service is set to a first value to indicate the MBMS service being scheduled or to a second value to indicate the MBMS service not being scheduled.

13. The apparatus of claim 11, wherein the plurality of MBMS services include all MBMS services supported by a cell.

14. The apparatus of claim 11, further comprising:
means for selecting a group of MBMS services among a plurality of groups of MBMS services formed for all MBMS services supported by a cell, wherein the selected group includes the plurality of MBMS services; and
means for sending information indicating the selected group.

15. The apparatus of claim 14, further comprising:
means for selecting at least one additional group of MBMS services among the plurality of groups of MBMS services;
means for generating at least one additional bitmap based on scheduling information for the at least one additional group of MBMS services; and
means for sending information indicating the at least one additional group and the at least one additional bitmap to convey the scheduling information for the at least one additional group of MBMS services.

16. An apparatus for supporting multimedia broadcast/multicast services (MBMS), comprising:
at least one processor configured to determine scheduling information for a plurality of MBMS services, to generate a bitmap based on the scheduling information, and to send at least the bitmap to convey the scheduling information.

17. The apparatus of claim 16, wherein the bitmap comprises a bit for each of the plurality of MBMS services, and wherein the bit for each MBMS service is set to a first value to indicate the MBMS service being scheduled or to a second value to indicate the MBMS service not being scheduled.

18. The apparatus of claim 16, wherein the plurality of MBMS services include all MBMS services supported by a cell.

19. The apparatus of claim 16, wherein the at least one processor is configured to select a group of MBMS services among a plurality of groups of MBMS services formed for all MBMS services supported by a cell, wherein the selected group includes the plurality of MBMS services, and to send information indicating the selected group.

20. The apparatus of claim 19, wherein the at least one processor is configured to select at least one additional group of MBMS services among the plurality of groups of MBMS services, to generate at least one additional bitmap based on scheduling information for the at least one additional group of MBMS services, and to send information indicating the at least one additional group and the at least one additional bitmap to convey the scheduling information for the at least one additional group of MBMS services.

21. A computer program product, comprising:
a non-transitory computer-readable medium comprising:
code for causing at least one computer to determine scheduling information for a plurality of multimedia broadcast/multicast services (MBMS) services,
code for causing the at least one computer to generate a bitmap based on the scheduling information, and
code for causing the at least one computer to send at least the bitmap to convey the scheduling information.

22. A method of receiving multimedia broadcast/multicast services (MBMS), comprising:
receiving a bitmap used to convey scheduling information for a plurality of MBMS services; and
determining whether at least one MBMS service among the plurality of MBMS services is scheduled based on the bitmap.

23. The method of claim 22, wherein the scheduling information indicates whether each of the plurality of MBMS services is scheduled in a current scheduling period.

24. The method of claim 22, wherein the determining whether the at least one MBMS service is scheduled comprises
determining at least one bit of the bitmap to which the at least one MBMS service is mapped, wherein the bitmap comprises a bit for each of the plurality of MBMS services, and
determining whether each of the at least one MBMS service is scheduled based on a value of a corresponding one of the at least one bit of the bitmap.

25. The method of claim 22, wherein the plurality of MBMS services include all MBMS services supported by a cell.

26. The method of claim 22, further comprising:
receiving information indicating a selected group of MBMS services among a plurality of groups of MBMS services formed for all MBMS services supported by a cell, and wherein the selected group includes the plurality of MBMS services.

27. The method of claim 26, further comprising:
receiving information indicating at least one additional group of MBMS services among the plurality of groups of MBMS services;
receiving at least one additional bitmap for the at least one additional group of MBMS services; and
determining whether at least one additional MBMS service in the at least one additional group is scheduled based on the at least one additional bitmap.

28. An apparatus for receiving multimedia broadcast/multicast services (MBMS), comprising:
means for receiving a bitmap used to convey scheduling information for a plurality of MBMS services; and
means for determining whether at least one MBMS service among the plurality of MBMS services is scheduled based on the bitmap.

29. The apparatus of claim 28, wherein the means for determining whether the at least one MBMS service is scheduled comprises
means for determining at least one bit of the bitmap to which the at least one MBMS service is mapped, wherein the bitmap comprises a bit for each of the plurality of MBMS services, and
means for determining whether each of the at least one MBMS service is scheduled based on a value of a corresponding one of the at least one bit of the bitmap.

30. The apparatus of claim 28, wherein the plurality of MBMS services include all MBMS services supported by a cell.

31. The apparatus of claim 28, further comprising:
means for receiving information indicating a selected group of MBMS services among a plurality of groups of MBMS services formed for all MBMS services supported by a cell, and wherein the selected group includes the plurality of MBMS services.

32. The apparatus of claim 31, further comprising:
means for receiving information indicating at least one additional group of MBMS services among the plurality of groups of MBMS services;
means for receiving at least one additional bitmap for the at least one additional group of MBMS services; and
means for determining whether at least one additional MBMS service in the at least one additional group is scheduled based on the at least one additional bitmap.

33. An apparatus for receiving multimedia broadcast/multicast services (MBMS), comprising:
at least one processor configured to receive a bitmap used to convey scheduling information for a plurality of MBMS services, and to determine whether at least one MBMS service among the plurality of MBMS services is scheduled based on the bitmap.

34. A computer program product, comprising:
a non-transitory computer-readable medium comprising:
code for causing at least one computer to receive a bitmap used to convey scheduling information for a plurality of multimedia broadcast/multicast services (MBMS) services, and
code for causing the at least one computer to determine whether at least one MBMS service among the plurality of MBMS services is scheduled based on the bitmap.
